(19) United States
(12) Patent Application Publication
(10) Pub. No.: US 2021/0092065 A1
(43) Pub. Date: Mar. 25, 2021

(54) MULTIHOP NETWORK ROUTING

(71) Applicant: Arm Limited, Cambridge (GB)

(72) Inventor: Lauri Ollinpoika Piikivi, Oulu (FI)

(21) Appl. No.: 16/994,807

(22) Filed: Aug. 17, 2020

(30) Foreign Application Priority Data
Sep. 25, 2019 (GB) 19138080

(51) Int. Cl. H04L 12/801

(52) U.S. Cl. CPC H04L 47/17; H04L 47/12

(57) ABSTRACT

Technology for operating a controlling router device configured to communicate with a multihop network. The technology includes adding at least a first packet and a second packet into a transmission queue at said controlling router; identifying for each of said first and said second packet a routing path via at least one intermediate node to a destination node in said multihop network; responsive to the identifying, analyzing for each of the first and the second packet, a path capacity of at least one intermediate node; and responsive to an outcome of the analyzing, adjusting transmission of each of the first and the second packet in accordance with at least one path capacity.

### RELATED APPLICATION

The present application claims priority to GB Application No. 19 13808.0 filed Sep. 25, 2019, which is hereby incorporated herein in its entirety by reference.

The present technology relates to methods and apparatus for routing traffic in multihop networks, especially radio networks, and more especially low-power and lossy networks (LLNs), where packet transmission congestion is common. In such networks, congestion and inter-node interference at intermediate nodes can have a severely negative effect on system operations, for example, by increasing the latency of an individual message. These difficulties are exacerbated as networks increase in size.

In a first approach to the many difficulties encountered in routing traffic in multihop networks, the present technology provides a machine-implemented method for operating a controlling router device in electronic communication with a multihop network, comprising: receiving at least a first packet and a second packet into a transmission queue at the controlling router; identifying for each of the first and the second packet a routing path via at least one intermediate node to a destination node in the multihop network; responsive to the identifying, analyzing for each of the first and the second packet a path capacity of each of the at least one intermediate node; and responsive to an outcome of the analyzing, adjusting transmission of each of the first and the second packet in accordance with at least one path capacity.

In a hardware approach, there is provided electronic apparatus comprising logic elements operable to implement the methods of the present technology. In another approach, the computer-implemented method may be realized in the form of a computer program product.

Implementations of the disclosed technology will now be described, by way of example only, with reference to the accompanying drawings, in which:

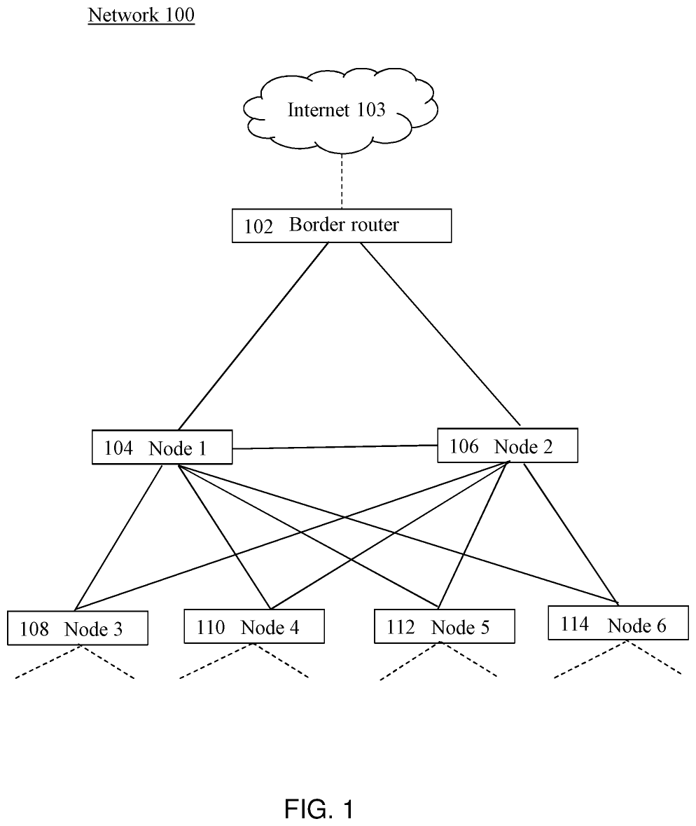

FIG. 1 shows a simplified view of some connections in a network in which the presently described technology may be implemented;

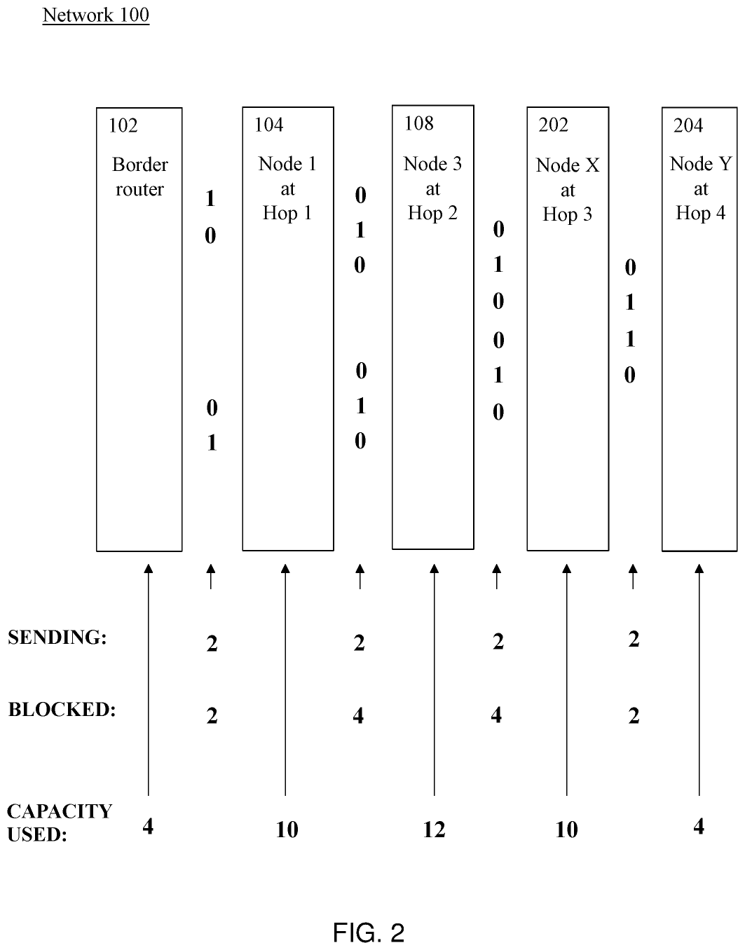

FIG. 2 shows a worked example of the operation of a path from a border router to a destination node in a multihop network;

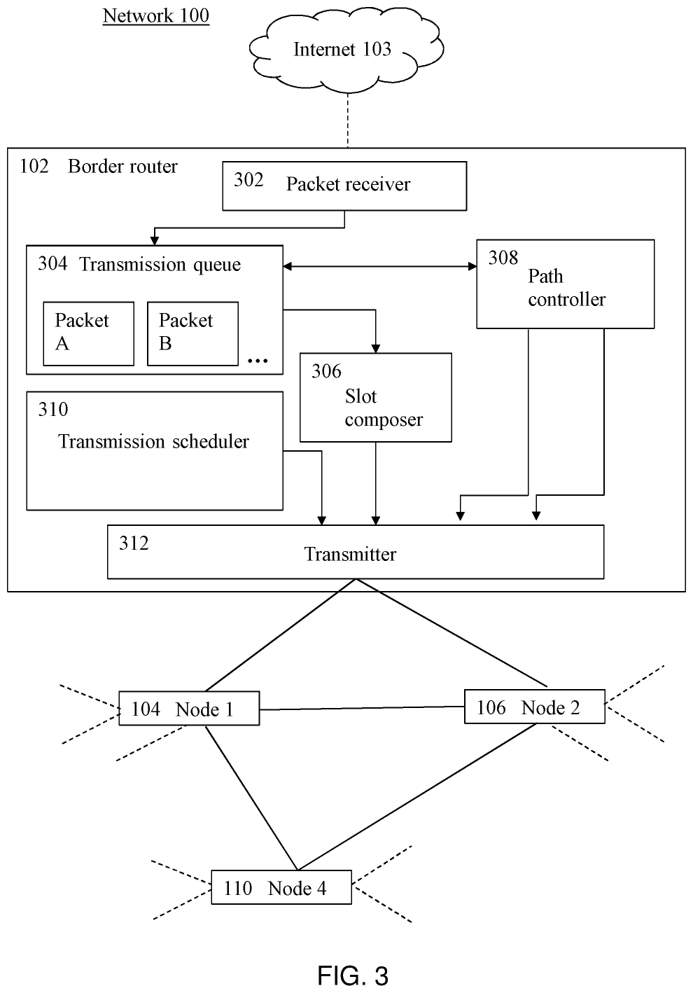

FIG. 3 shows a block diagram of an arrangement of logic, firmware or software components by means of which the presently described technology may be implemented; and

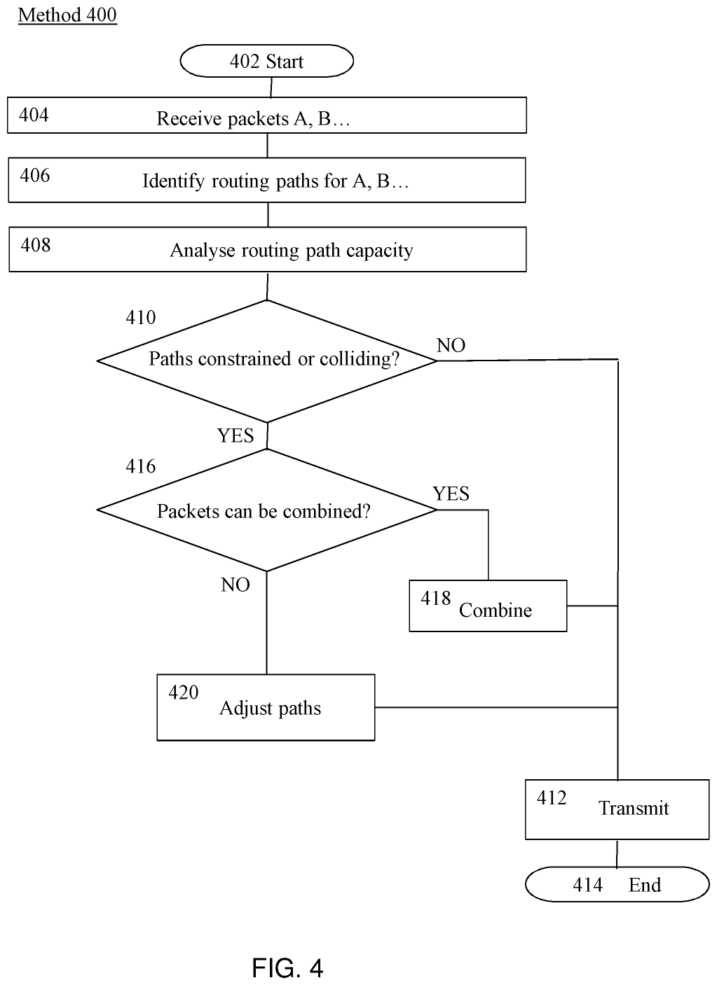

FIG. 4 shows one example of a method of operating a network according to an implementation of the presently described technology.

The present technology thus provides computer-implemented techniques and logic apparatus for routing traffic in multihop networks while providing the potential for optimization of network capacity by intelligent packet queuing and routing in the border router. Implementations of the present technology are operable to use node location information (which may be physical location information or “logical” location information for the intermediate nodes in the paths to the destination nodes) to analyze the constraints and potential collisions on the paths and to adjust transmissions accordingly.

Because of the power consumption economies that can be gained by exploiting the spreading of power consumption inherent in their hop-by-hop signal propagation methods, such networks are frequently implemented in low-power and lossy networks (LLNs). LLNs typically consist largely of constrained devices having limited processing power, memory, and sometimes energy, particularly when they are battery operated or energy-harvesting. These nodes are interconnected by lossy links, typically supporting only low data rates, that are typically unstable and may consequently have relatively low packet delivery rates.

LLNs are thus often advantageously arranged as multihop networks, such as mesh networks, in which attached devices may act both as leaf nodes performing operations and transmitting/receiving on their own behalf, and also as routers for other attached devices. A transmission in such a network thus normally proceeds in a hop-by-hop fashion from its source device to its target device or devices via one or more intermediate attached devices. Each of these single-hop transmissions is vulnerable to blocking at intermediate nodes because a receiving node is already transmitting another, unrelated packet, and thus cannot receive the new transmission—thus packets may be sent to a destination device over channels that may intersect at intermediate nodes, potentially causing collisions and consequent delays. Routing in networks of this type typically operates according to the directed acyclic graph model, Destination Oriented Directed Acyclic Graphs (DODAG), which determines routes from source nodes to destination nodes using fairness and resource balancing algorithms. Examples of networks that follow the DODAG model are 6LoWPAN and Wi-SUN mesh networks.

Turning now to FIG. 1, there is shown a much simplified view of a reduced set of connections in a mesh network such as a multihop mesh network (for example, one using Routing Protocol for Low power and Lossy Networks (RPL)). As described above, in such a network, packets are routed hop-by-hop from originator to destination, typically by way of one or more intermediate nodes. In the present arrangement, it will be seen that network 100 comprises a controlling router device, such as a border router 102, which is connected to the Internet 103 and to other, non-border-router nodes in the network. These nodes may be located at differing numbers of hops from the border router 102. Thus, for example, Node 1 104 and Node 2 106 are located (physically or logically) at one hop from the border router 102, while nodes 3, 4, 5 and 6 (respectively 108, 110, 112, 114) are located at two hops from border router 102. As will be clear to one of skill in the art, the representation of network 100 in FIG. 1 is much simplified, and in any real-world implementation, many more nodes and a much more complex mesh of interconnections would exist.

FIG. 2 shows a high-level presentation of transmission propagation in a multihop network 100, which may be a wired or wireless network. In FIG. 2, the border router 102 connects the network to the Internet, and is thus typically busy with sending and receiving transmissions on behalf of destination nodes in the multihop network at various hop counts from the border router. In the present example, Node Y 204 is the destination for a packet from the border router 102, and thus must pass through Node 1 104, Node 3 108 and Node X 202 before being received at destination Node Y 204. A return message from Node Y 204 to border router 102 must follow a similar path in reverse through the intermediate nodes.

The gaps between border router 102 and Node 1 104, between intermediate nodes 104, 108, 202, and between Node X 202 and destination Node Y 204 are bridged by transmission channels which can at any time be in one of two states: state 1 meaning that data can be transmitted, and state 0 meaning that data cannot be sent, as the recipient is sending data to another node and cannot receive at the same time. In the example, border router 102 sends a message to Node at hop 4 204 and receives a response. The states of the transmission channels are shown in time sequence descending and from left to right. Thus, border router sends to Node 1 104, and the channel state is 1. During this transmission, Node 1 cannot transmit, and thus its state is 0. In the sending and receiving sequence of this example, it will be seen that the channel between border router 102 and Node 1 104 is in send state 1 twice and is in blocked state 0 twice, thus consuming 4 units of capacity. By tracking the outbound transmission through its path to Node Y 204 and the inbound transmission from Node Y 204 back to border router 102, it will be seen that the capacity used by intermediate nodes increases to a maximum at the midway node, in this example, Node 3 108, which is in send state 1 twice in each direction of transmission flow and in blocked state 0 four times in each direction of transmission flow, thus consuming 12 units of capacity. Any alleviation of such congestion will be beneficial to the performance of the network. The problem of congestion causing constraint at an intermediate node has been shown for a very simple pair of messages in the FIG., but it will be clear to one of skill in the art that any real world situation will involve many messages that need to interleave to pass through the channels from the border router to the destination nodes, and that the constraints on capacity in the intermediate nodes will affect the efficiency of the network by introducing delays where intermediate nodes are blocked.

Due to the hop-by-hop transmission of the data, the routing nodes midway in the path suffer greater capacity usage, as they receive the data and send it forward. During the time of sending, they cannot be receiving, and vice versa. This causes the packet to use more capacity resource in the network, as possible communication from other nodes suffers from the capacity constraints. It should be noted that, because networks of the type described herein typically operate according to the directed acyclic graph model, Destination Oriented Directed Acyclic Graphs (DODAG), the border router 102 is the only component that can influence the route the data takes through the network. Intermediate nodes are only capable of receiving and forwarding messages according to the DODAG model.

As described above, when networks that follow the DODAG model (such as 6LoWPAN and Wi-SUN mesh networks) access the Internet, the border router 102 is the common point for all inbound and outbound transmissions, which renders the border router 102 itself a critical point of the system. As mesh network transmission means, such as radios, are slow, the border router 102 often will have a queue of packets coming from the faster Internet going to the slow mesh, and when communications in a cloud system are directed to logical groups of destination devices, this kind of packet batching will occur more often.

In implementations of the present technology, for data coming to the border router 102 and aimed at destination nodes in the network, the border router 102 queues the packets, and by analyzing the capacity usage of intermediate nodes deeper in the network it can, for example, adjust the sending order or other factors in the onward transmission parameters based on information about the path to the destination.

In its simplest form, the analysis of capacity usage may be based on information held by the border router 102, such as the possible routes to each potential destination node as assembled by a routing protocol (such as the Routing Protocol for Lossy Networks—RPL), and the knowledge that any intermediate node cannot be in both a send state and a receive state at the same time. The routing protocol thus provides a map of the intermediate nodes for each packet to be sent and the present technology can combine this information with the real-time information it has about the state of each intermediate node to determine the likelihood of congestion at a common node in both routes. Taking any two packets in the queue and knowing their routes, the potential for a first packet to block a subsequent packet at an intermediate node can thus be seen by the border router 102, and the packet routing or timing can be accordingly adjusted. In another example scenario, if a node is both a destination node for a first packet and an intermediate node for a further packet, the packet routing or timing, or the node's processing of its targeted packet may be adjusted to alleviate any blocking issues.

In a refinement, each border router 102 may be provided with a service operable to analyze routing information for packets in the queue and, for each intermediate node, detect one-hop neighbors available for onward routing and parents from which packets may be routed. This information may then be assembled into a map of the potential route for each packet. Further information from intermediate nodes, such as their maximum memory availability and queue length may then be factored into any calculations as to potential congestion at the intermediate nodes. This information may then be used in the routing and timing adjustments made to avoid blocking or contention at the intermediate nodes to the extent that is possible in the given network arrangement.

In an example of adjustment of transmission parameters, the border router 102 may fit together packets that share intermediate nodes in their paths in order to utilize the capacity of those nodes to the maximum—packets may be fitted together, if they are appropriately sized, to occupy a single transmission slot over the transmission channels. Secondly, as the border router 102 has information about the sending and reception impact that packet transmission has on the total capacity usage for a routing node, it can distribute the packet transmissions so that they do not share common paths, thus avoiding a potential bottleneck on its own transmission channel and any detected further bottlenecks in the mesh network. The packets in the queue may also be reordered before being transmitted to avoid blocking or contention at the intermediate nodes.

For example, if there are packets 1, 2, 3 in the border router queue with routing information 1:A-B-C, 2:A:-B-D and 3:H-I-J the optimal sending order would be first 1:A-B-C, then 3:H-I-J and lastly 2:A-B-D. In this case A has time to forward the message 1 and the border router 102 is not blocked in sending message 2 waiting for node A to forward message 1. This also impacts memory buffer needs for routed packets. If the border router calculates that packets 1 and 2 fit into the same radio transmission slot capacity, it could combine them for optimizing its own transmission channel usage. In its simplest form, the biggest bottleneck of the border router link is thus optimized by analysis and consequent adjustment of this first hop for each packet. Further bottlenecks may then be addressed by adjusting onward routes according to the analysis described above.

In networks that use radio links, additional location information of the border router and nodes may be used to control the direction and amplification of the transmissions. As the radios near each other interfere with each other, using less power means other nodes in the network see less radio interference. Amplification may be adjusted based on the link metrics known to the border router and intermediate nodes for the radio link. In a further refinement, knowing the physical location of a node may allow directed transmission, minimizing interference on nodes not in the transmission direction. The angle or distance between nodes cannot be deduced from the routing path information, but additional location based on GPS or antenna direction parameters may also be taken into account.

Turning now to FIG. 3, there is shown a block diagram of an exemplary processing arrangement comprising logic components, firmware components or software components by means of which the presently described technology may be implemented. FIG. 3 shows a network 100 having a border router 102 attached to the Internet 103 and in electronic communication at hop 1 with at least Node 1 104 and Node 2 106. Node 4 110 is attached to the network at hop 2, and is in electronic communication with other nodes in the network, including at least Node 1 104 and Node 2 106.

Border router 102 comprises packet receiver 302, operable at least to receive packets from nodes in the network and from the Internet 103. Where packets are received from the Internet 103 for onward routing to destination nodes in the network, they are placed in transmission queue 304 (here shown as containing Packet A, Packet B . . . ). Packets from transmission queue are onwardly transmitted by transmitter 312, which receives packets from transmission queue 304 by way of slot composer 306, which is operable to compose the contents of channel transmission slots. The contents of each channel transmission slot may comprise one or more packets assembled by slot composer 306. Transmitter 312 is further in communication with path controller 308, which is operable to analyze and adjust parameters of the paths by which packets are transmitted, in collaboration with transmission scheduler 310, which is operable to schedule the transmission of packets in the channel transmission slots. In one worked example, a packet received from the Internet 103 at packet receiver 302 has a destination of Node 4 110. The packet is placed in transmission queue 304 its path is analyzed by path controller 308, and its size is assessed by slot composer 306. In the present example, slot composer 306 is operable to determine that the packet size is such that it needs a whole channel transmission slot. Path controller 308 is operable to assess that the normal path to Node 4 110 by way of Node 1 104 is congested and, depending on other path congestion information, may determine that it should be transmitted by way of Node 2 106 to destination Node 4 110. Transmission scheduler 310 is operable to assess the path timings of the routes available for transmission and to determine a best-available transmission schedule for packets in transmission queue 304, including the example packet, and is further operable to schedule its transmission by transmitter 312.

In FIG. 4 there is shown one example of a method of operating a network 400 according to an implementation of the presently described technology. The method begins at start step 402, and at 404, packets are received into a transmission queue at a controlling router, such as a border router 102. Routing paths for the packets are identified at 406, and at 408, routing path capacity for those routing paths is analyzed. If the paths are assessed at test step 410 to be not constrained or subject to packet collisions, the packets are transmitted at step 412 and the process completes at end step 414. As will be clear to one of skill in the art, end step 414 completes an instance of the method, and in any real-world scenario, the process will be iterative.

If the paths are assessed at test step 410 to be constrained or subject to packet collisions, at 416 a test is performed to determine whether packets can be combined into a single transmission channel slot in such a way as to alleviate the constraint. If the test at 416 determines that packets can be combined into a single transmission channel slot in such a way as to alleviate the constraint, they are combined at 418 and transmitted at 412. The process completes at end step 414. As stated above, end step 414 completes an instance of the method, and in any real-world scenario, the process will be iterative.

If the test at 416 determines that packets cannot be combined into a single transmission channel slot in such a way as to alleviate the constraint, the transmission paths are adjusted at 420 according to the outcome of the analysis of routing path capacity at 408. The packets are transmitted at 412, and the process completes at end step 414. As stated above, end step 414 completes an instance of the method, and in any real-world scenario, the process will be iterative.

As will be appreciated by one skilled in the art, the present technique may be embodied as a system, method or computer program product. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments.

Furthermore, the present technique may take the form of a computer program product embodied in a non-transitory computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction-set to high-level compiled or interpreted language constructs.

It will also be clear to one of skill in the art that all or part of a logical method according to embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored using fixed carrier media.

In one alternative, an embodiment of the present techniques may be realized in the form of a computer implemented method of deploying a service comprising steps of deploying computer program code operable to, when deployed into a computer infrastructure or network and executed thereon, cause said computer system or network to perform all the steps of the method.

In a further alternative, an embodiment of the present technique may be realized in the form of a data carrier having functional data thereon, said functional data comprising functional computer data structures to, when loaded into a computer system or network and operated upon thereby, enable said computer system to perform all the steps of the method.

It will be clear to one skilled in the art that many improvements and modifications can be made to the foregoing exemplary embodiments without departing from the scope of the present technique.

1. A machine-implemented method for operating a controlling router device configured to communicate with a multihop network, comprising:
adding at least a first packet and a second packet into a transmission queue at said controlling router;
identifying for each of said first and said second packet a routing path via at least one intermediate node to a destination node in said multihop network;
responsive to said identifying, analyzing for each of said first and said second packet, a path capacity of the at least one intermediate node; and
responsive to an outcome of said analyzing, adjusting transmission of each of said first and said second packet in accordance with at least one said path capacity.

2. The machine-implemented method according to claim 1, said analyzing comprising comparing a said routing path for a first said packet with a routing path for a said second packet to identify a common intermediate node.

3. The machine-implemented method according to claim 1, said adjusting comprising adjusting a selection of said at least one intermediate node.

4. The machine-implemented method according to claim 1, said adjusting comprising adjusting a transmission timing of at least one of said first and said second packet.

5. The machine-implemented method according to claim 1, said adjusting comprising reordering packets in said transmission queue.

6. The machine-implemented method according to claim 3, said adjusting comprising adjusting to avoid a contention between said first and said second packet at least one said intermediate node.

7. The machine-implemented method according to claim 1, said adjusting comprising combining said first and said second packet for transmission in a single transmission slot.

8. The machine-implemented method according to claim 1, further comprising adjusting a radio signal amplification to reduce inter-node interference.

9. The machine-implemented method according to claim 1, further comprising adjusting a radio signal direction to reduce inter-node interference.

10. The machine-implemented method according to claim 1, said controlling router device comprising a border router mediating between said multihop network and an external network.

11. A controlling router device comprising logic operable to perform the steps of the method according to claim 1.

12. A computer program comprising computer program code to, when loaded into a computer system and executed thereon, perform all the steps of the method according to claim 1.
